(19) United States
(12) Patent Application Publication
(10) Pub. No.: US 2015/0215385 A1
(43) Pub. Date: Jul. 30, 2015

(54) SYSTEM AND METHOD FOR OVERLAYING CONTENT ITEMS OVER MULTIMEDIA CONTENT ELEMENTS RESPECTIVE OF USER PARAMETERS

(71) Applicant: Cortica, Ltd., RAMAT GAN (IL)

(72) Inventors: Igal Raichelgauz, New York, NY (US); Karina Odinaev, New York, NY (US); Yehoshua Y. Zeevi, Haifa (IL)

(73) Assignee: CORTICA, LTD., RAMAT GAN (IL)

(21) Appl. No.: 14/606,546

(22) Filed: Jan. 27, 2015

Related U.S. Application Data
(60) Provisional application No. 61/931,919, filed on Jan. 27, 2014.

(51) Int. Cl. H04L 29/08; G09G 5/377; H04L 12/927

(52) U.S. Cl. CPC H04L 67/10; H04L 47/808; G09G 5/377

(57) ABSTRACT

A method and system for overlaying content items over multimedia content elements are provided. The method includes receiving a request to overlay at least one content item over at least one portion of a multimedia content element from a first user device; receiving permissions data for viewing the at least one content item from the first user device; overlaying the at least one content item over the at least one portion of the multimedia content element to produce an overlaid multimedia content element; storing the overlaid multimedia content element with the respective permissions data in a storage; receiving a request from a second user device to provide the stored overlaid multimedia content element; checking that the second user device is authorized to display the stored overlaid multimedia content element based on the permissions data; and providing the respective overlaid multimedia content element if the first user device is authorized.

### CROSS REFERENCE TO RELATED APPLICATIONS

This application claims the benefit of U.S. provisional application No. 61/931,919 filed on Jan. 27, 2014, the contents of which are herein incorporated by reference.

### TECHNICAL FIELD

The present disclosure relates generally to the analysis of multimedia content, and more specifically to a system for overlaying content items over multimedia content elements.

### BACKGROUND

The Internet, also referred to as the worldwide web (WWW), has become a mass media source where every client can easily upload and download multimedia content. Some people tend to do so in order to share their creations, ideas, likes, dislikes, and thoughts with users all around the world. Others tend to do so for commercial motives. For example, painters may sell their paintings and poets may sell their poems over the Internet.

Often is the case where a user wishes to share content with a plurality of users respective of certain parameters related to the users, such as age, interests, location, etc. Currently, there is no existing solution that enables one to do so. Sharing content with specific users based on such parameters would likely increase the quality of commercial advertising and the quality of personal interactions by increasing the likelihood that the recipient of the content will appreciate the content.

It would be therefore advantageous to provide a solution for allowing users to share content respective of certain parameters.

### SUMMARY

A summary of several exemplary embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a method and system for overlaying content items over multimedia content elements. The method comprises receiving a request to overlay at least one content item over at least one portion of a multimedia content element from a first user device; receiving permissions data for viewing the at least one content item from the first user device; overlaying the at least one content item over the at least one portion of the multimedia content element to produce an overlaid multimedia content element; storing the overlaid multimedia content element with the respective permissions data in a storage; receiving a request from a second user device to provide the stored overlaid multimedia content element; checking that the second user device is authorized to display the stored overlaid multimedia content element based on the permissions data; upon determining that the second user device is authorized to display the stored overlaid multimedia content element, retrieving from the storage the respective overlaid multimedia content element; and sending the overlaid multimedia content element to the second user device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network system for demonstrating the disclosed embodiments of overlaying content items over multimedia content elements.

FIG. 2 is a flowchart illustrating the process of overlaying content items over multimedia content elements according to an embodiment.

FIG. 3 is a block diagram illustrating the process of providing an overlaid multimedia content element responsive to a request according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein enable overlaying of content items over multimedia content elements viewed by a user device. A request to overlay at least one content item over at least one portion of a multimedia content element from a first user device is received. Permissions data for viewing the at least one content item from the first user device is also received. Then, a content item is overlaid over the at least one portion of the multimedia content element. The multimedia content element is stored in a storage together with the generated overlay. Upon receiving a request from a second user device to provide the stored multimedia content element, it is checked whether the second user device may receive the overlaid multimedia content respective of the overlaying content item permissions data. The multimedia content item may be provided with the generated overlay from the storage.

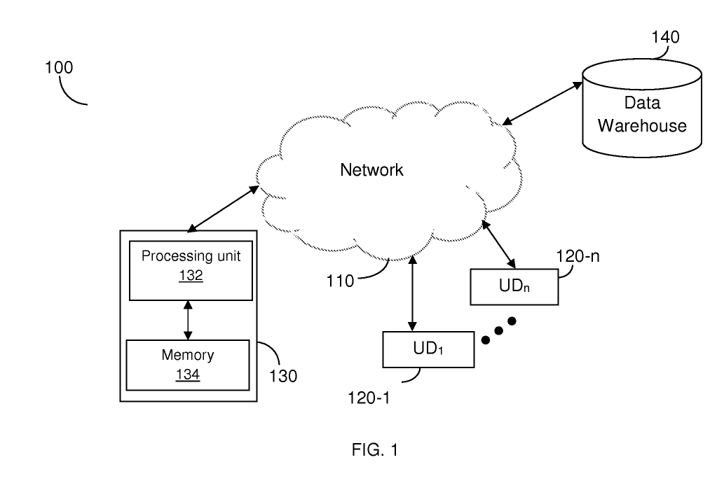

FIG. 1 shows an exemplary and non-limiting schematic diagram of a network system 100 utilized for demonstrating an embodiment of overlaying content items over multimedia content elements according. A network 110 is used to communicate between different elements of the system 100. The network 110 may be the Internet, the world-wide-web (WWW), a local area network (LAN), a wide area network (WAN), a metro area network (MAN), and other wired and wireless networks capable of enabling communication between the elements of the system 100.

Further connected to the network 110 are one or more user devices 120-1 through 120-n (collectively referred to hereinafter as user devices 120 or individually as a user device 120, merely for simplicity purposes). A user device 120 may be, but is not limited to, a personal computer (PC), a personal digital assistant (PDA), a mobile phone, a tablet computer, a wearable computing device, and other kinds of wired and mobile appliances equipped with viewing, receiving, and managing capabilities, that are enabled as discussed further herein below.

A server 130 is further connected to the network 110 and may receive multimedia content from the user devices 120. It should be noted that the server 130 typically comprises a processing unit 132 coupled to a memory 134. The memory 134 contains instructions that can be executed by the processing unit 132. The server 130 also typically includes an interface (not shown) to the network 110.

The processing unit 132 may comprise, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 132 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit, cause the processing unit to perform the various functions described herein.

In one embodiment, the processing unit may be realized through architecture of computational cores described in detail in U.S. Pat. No. 8,655,801 to Raichelgauz, et al., which is assigned to a common assignee, and is hereby incorporated by reference for all that it contains.

A data warehouse 140 is connected to the server 130 (either directly or indirectly through the network 110) and is configured to store one or more of the multimedia content elements and one or more content items.

According to the embodiments disclosed herein, the server 130 is configured to receive a request to overlay at least one content item over at least one portion of a multimedia content element from a first user device such as, for example, the user device 120-1. The request includes, without limitation, the multimedia content element, a selection of portion(s) of the multimedia content element, and/or a link thereto. A multimedia content element may include, but is not limited to, an image, a graphic, a video stream, a video clip, an audio stream, an audio clip, a video frame, a photograph, an image of signals (e.g., spectrograms, phasograms, scalograms, etc.), combinations thereof, and portions thereof. The received request may also include the content item to be overlaid. Such content item may be, for example a text, an image, a link, a combination thereof, a portion thereof, and so on.

The server 130 is further configured to receive permissions data for viewing the at least one content item from the first user device 120-1. The permissions data is a threshold determined by a user of the user device 120-1 for viewing the overlaid content item. Permissions data may be time based, location based, content based, user based, a combination thereof, and so on. As a non-limiting example, a user may only be provided content that meets the user's current interests. According to one embodiment, the permissions data may be public. In such a case, any user device will have the permission for viewing the overlaid content. In another embodiment, the permissions data may be private. In such an embodiment, only certain users may view the overlaid content. For example, the permissions data may require that the user be a particular user or that the user enter a password prior to viewing.

Respective of the request, the server 130 is configured to generate an overlay over the at least one selected portion of the multimedia content element. The overlay comprises the at least one content item. The server 130 is configured to store the multimedia content element in a storage together with the generated overlay. The storage may be, for example, the data warehouse 140. Upon receiving a request from a second user device 120-2 to provide the stored multimedia content, the server 130 is configured to check if the second user device 120-2 may receive the stored multimedia content respective of the permissions data received from the first user device 120-1.

In an embodiment, upon determination that the second user device 120-2 may receive the overlaid multimedia content, the server 130 is further configured to provide the multimedia content item with the generated overlay from the data warehouse 140. According to one embodiment, the first user device 120-1 is the same user device as the second user device 120-2. In that embodiment, the original user device 120-1 may subsequently request the same multimedia content item.

As a non-limiting example, an image of an Italian restaurant is received by the server 130 from a user device 120-1. The image includes a textual content item added by the user of the user device 120-1 stating: “very good vegetarian lasagna and fair prices for business lunch.” The server 130 further receives permissions data for viewing the image together with the textual content item from the user device 120-1. The permissions data includes a time-based threshold, which is between 12 P.M. to 3 P.M. local time at the restaurant zone. The server 130 then sends the overlaid image for storage in the data warehouse 140.

Upon receiving a request for the stored image by a user device, for example the user device 120-2, the server 130 is configured to check the permissions data of the image. If the request was received from the user device 120-2 during the time threshold, the overlaid image is sent to the user device 120-2 by the server 130. For example, the user of the user device 120-2 may be viewing the Italian restaurant on a website for making reservations, such as OpenTable.com® at 1 P.M. Since the user is viewing the website within the time threshold, the image and textual content item may be provided to the user device as an overlay.

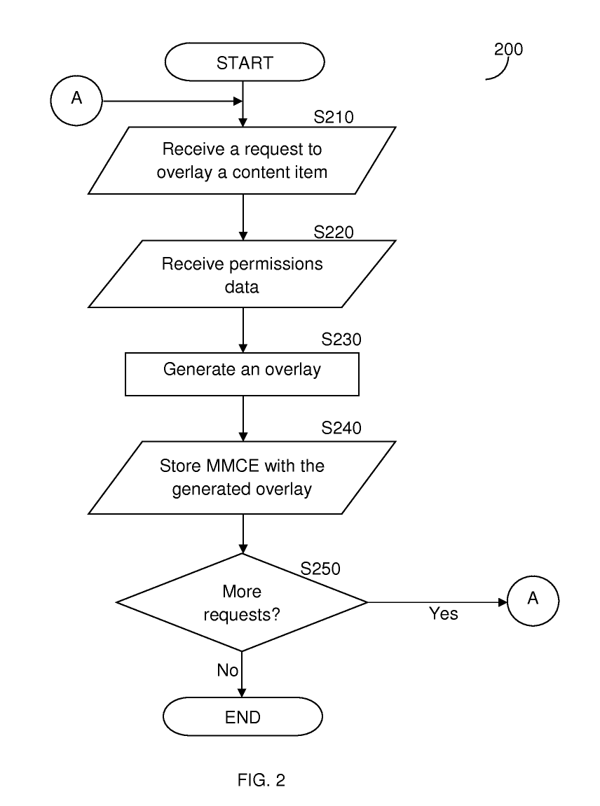

FIG. 2 is an exemplary and non-limiting flowchart 200 depicting a method of overlaying content items over multimedia content items according to an embodiment. In S210, a request to overlay a content item over a multimedia content element is received from a user by means of a user device (e.g., the user device 120-1. In an exemplary embodiment, the request includes, for example, a multimedia content item and the content item to be overlaid. Such content item may be, for example, text, an image, a link, a combination thereof, a portion thereof, and so on. According to one embodiment, the request may also include a selection of a portion of the multimedia content element over which the user wishes to have the content item overlaid. In one embodiment, the request can be received from an agent (e.g., an add-on) installed in the user device. The user device may include, for example, an application, an executable program, a web browser, and the like.

In S220, permissions data for viewing the multimedia content element to be overlaid with the overlaid content item is received. The permissions data may be received by the server 130 from a user device providing the content item. Permissions data may be, for example, time based, location based, content based, user based, and a combination thereof. In S230, an overlay is generated over the multimedia content element respective of the permissions data. The overlay includes the received content item.

In S240, the multimedia content element together with the generated overlay is stored in a storage. The storage may be the data warehouse 140. In S250, it is checked whether there are additional requests, and if so, execution continues with S210; otherwise, execution terminates.

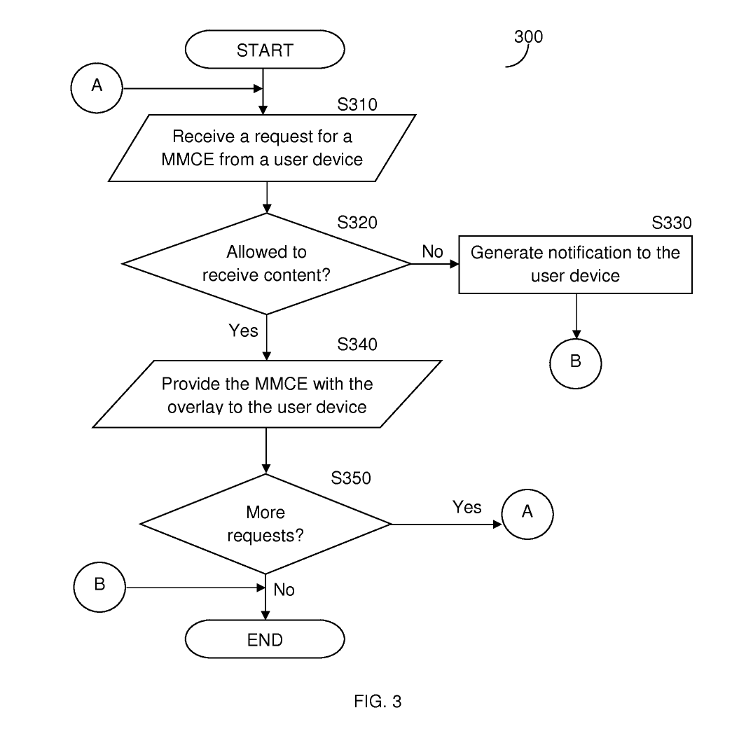

FIG. 3 is an exemplary and non-limiting flowchart 300 illustrating a method of providing an overlaid multimedia content element responsive to a request according to one embodiment. In S310, a request for a multimedia content element is received from a user device such as, for example, the user device 120-2. The request may be received in response to a user's gesture, a capture of the multimedia content element by a sensor of the user device 120-2, and so on. A user's gesture may be, for example, a scroll, a tap, or a press on a certain area of the display of the user device 120-2.

In S320, it is checked whether the user device 120-2 is authorized to display the overlaid multimedia content element. The check is performed respective of the permissions data of the overlaid content item. If so, execution continues with S340; otherwise, execution continues with S330. In optional S330, a notification that the user device 120-2 cannot receive the overlaid multimedia content element is sent to the user device and execution terminates.

In S340, the multimedia content item with the overlaid content item is provided to the user device requesting such content. In S350, it is checked whether there are additional requests and if so, execution continues with S310; otherwise, execution terminates.

In an embodiment, the methods discussed with respect to FIGS. 2 and 3 can be performed by, for example, the server 130 or any other computing device configured to perform methods and embodiments disclosed herein.

A person of ordinary skill in the art would readily appreciate that the operation of overlaying content items over multimedia content elements described in FIG. 2 and the operation of the method for providing an overlaid multimedia content element responsive to a request described in FIG. 3 may be integrated without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for overlaying content items over multimedia content elements, comprising:
receiving a request to overlay at least one content item over at least one portion of a multimedia content element from a first user device;
receiving permissions data for viewing the at least one content item from the first user device;
overlaying the at least one content item over the at least one portion of the multimedia content element to produce an overlaid multimedia content element;
storing the overlaid multimedia content element with the respective permissions data in a storage;
receiving a request from a second user device to provide the stored overlaid multimedia content element;
checking that the second user device is authorized to display the stored overlaid multimedia content element based on the permissions data;
upon determining that the second user device is authorized to display the stored overlaid multimedia content element, retrieving the respective overlaid multimedia content element from the storage; and
sending the overlaid multimedia content element to the second user device.

2. The method of claim 1, wherein the storage is any one of: a database, and a data warehouse.

3. The method of claim 1, further comprising:
upon determining that the second user device is authorized, generating a notification that the overlaid multimedia content element was successfully sent.

4. The method of claim 1, further comprising:
upon determination that the second user device is not authorized, generating a notification that the overlaid multimedia content element was not successfully provided.

5. The method of claim 1, wherein the multimedia content element is at least one of: an image, graphics, a video stream, a video clip, an audio stream, an audio clip, a video frame, a photograph, images of signals, and a combination thereof.

6. The method of claim 1, wherein the second user device is the first user device.

7. The method of claim 1, wherein the permissions data is at least one of: time based, location based, content based, and user based.

8. The method of claim 1, wherein the permissions data is public.

9. A non-transitory computer readable medium having stored thereon instructions for causing one or more processing units to execute the method according to claim 1.

10. A system for overlaying content items over multimedia content elements, comprising:
a storage;
a processing unit; and
a memory connected to the processing unit, the memory containing instructions that, when executed by the processing unit, configure the system to:
receive a request to overlay at least one content item over at least one portion of a multimedia content element from a first user device;
receive permissions data for viewing the at least one content item from the first user device;
overlay the at least one content item over the at least one portion of the multimedia content element to produce an overlaid multimedia content element;
store the overlaid multimedia content element with the respective permissions data in the storage;
receive a request from a second user device to provide the stored overlaid multimedia content element;
check that the second user device is authorized to display the stored overlaid multimedia content element based on the permissions data;
upon determining that the second user device is authorized to display the stored overlaid multimedia content element, retrieve the respective overlaid multimedia content element from the storage; and
send the overlaid multimedia content element to the second user device.

11. The system of claim 10, wherein the system is further configured to:
generate a notification that the multimedia content element was successfully sent, upon determination that the second user device is authorized.

12. The system of claim 10, wherein the system is further configured to:
generate a notification that the overlaid multimedia content element was not successfully provided, upon determination that the second user device is not authorized.

13. The system of claim 10, wherein the multimedia content element is at least one of: an image, graphics, a video stream, a video clip, an audio stream, an audio clip, a video frame, a photograph, images of signals, and a combination thereof.

14. The system of claim 10, wherein the second user device is the first user device.

15. The system of claim 10, wherein the permissions data is at least one of: time based, location based, content based, and user based.

16. The system of claim 10, wherein the permissions data is public.
